(19) United States
(12) Patent Application Publication
(10) Pub. No.: US 2008/0096784 A1
(43) Pub. Date: Apr. 24, 2008

(54) Composition for Cleaning Dental Instruments and Process

(75) Inventors: Andree Barg, Otterndorf (DE); Manfred Thomas Plaumann, Cuxhaven (DE)

Correspondence Address: AKERMAN SENTERFITT, P.O. BOX 3188, WEST PALM BEACH, FL, 33402-3188, US

(73) Assignee: VOCO GmbH, Cuxhaven (DE)

(21) Appl. No.: 11/866,884

(22) Filed: Oct. 3, 2007

Related U.S. Application Data
(63) Continuation-in-part of application No. PCT/EP2006/062315, filed on May 15, 2006.

(30) Foreign Application Priority Data
Dec. 11, 2006 (EP) 06 125 777.0
Dec. 11, 2006 (CA) 2,570,970

(51) Int. Cl. C11D 3/33

(52) U.S. Cl. 510/161

(57) ABSTRACT

A composition for cleaning dental instruments, comprising or consisting of: (a) one or more amino acids and/or salts thereof (aminocarboxylates) in a total amount of from 20 to 70 parts by weight, preferably 27.5 to 70 parts by weight, (b) one or more alpha-hydroxy acids and/or salts thereof in a total amount of from 15 to 45 parts by weight, (c) one or more alkali metal carbonates and/or bicarbonates in a total amount of from 0 to 50 parts by weight, (d) one or more surfactants in a total amount of from 0 to 5 parts by weight, (e) one or more tabletting auxiliaries in a total amount of from 0 to 10 parts by weight, (f) one or more corrosion inhibitors in a total amount of from 0 to 5 parts by weight, and (g) one or more other additives in a total amount of from 0 to 55 parts by weight, wherein components (a), (b), (c), (d), (e), (f) and (g) are present in total in an amount of 100 parts by weight, and wherein the components are chosen such that the pH of a solution prepared by mixing the composition with 4,000 parts by weight of water is in the range of from 7.0 to 9.5.

### BACKGROUND OF THE INVENTION

1. Field of the Invention

The invention relates to a composition for cleaning dental instruments, in particular to remove acid-base cement residues, and a corresponding process.

2. Description of the Related Art

In the dental practice, instruments and equipment, such as impression trays, forceps, pliers etc., required for examination and treatment must be cleaned to remove contamination adhering to the surface. In present-day dental treatment, an impression of the patient's dentition is taken with a view to providing prostheses from inlay work produced in the laboratory, such as crowns, bridges, inlays, partial crowns etc. For this, the patient must bite into a so-called “impression tray” (moulding tray) filled with a soft impression composition. The teeth of the dentition displace the impression composition, so that a negative mould results, which cures and can be pulled away from the patient's dentition. The negative mould can now be cast with filler compositions and a positive impression produced. In this context, an exact reproduction of the details to be reproduced is required.

When the impression composition is removed from the impression tray, as a rule some of the cured impression composition remains stuck to the tray. Cleaning of the impression tray is a difficult working operation because simple washing by hand using a brush is not sufficient. Due to the geometric design of the impression tray, the impression composition can stick in the grooves or openings thereof, so that removal of the material is even more difficult to achieve.

To avoid the difficulty of cleaning dental impression trays, disposable impression trays of plastic are marketed. After use, the contaminated tray is simply thrown away. However, the use of disposable impression trays of plastic is uneconomical for cost reasons and ecologically disadvantageous.

The most usual material for creating an anatomical impression of fully toothed, partly toothed and toothless jaws are alginates, the water-soluble salts of water-insoluble alginic acid. Alginic acid is a polyuronic acid and consists of 1,4-glycosidically linked D-mannuronic acid and L-guluronic acid having up to 750 units. It is obtained from red and brown algae and is converted into the corresponding salts. The principle of creating alginate impressions comprises conversion of the water-soluble sodium, potassium or ammonium salts into the water-insoluble calcium, lead or barium alginates by reaction of the water-soluble salts with calcium sulfate or suitable lead or barium salts. The setting process is started by dissolving a powder which contains a water-soluble salt of alginic acid and a suitable further salt, such as e.g. calcium sulfate, in water. A sol initially forms, which rapidly passes into the gel state, since the water-soluble salt of alginic acid reacts with the further salt and precipitates out irreversibly as a sparingly soluble alginate, e.g. calcium alginate. Chemically, the setting reaction is thus an ion exchange reaction in which the metal ions change places at positions where the carboxylate groups of the alginate can be satisfied coordinatively.
Further important impression materials are zinc oxide-eugenol pastes. These materials are two-component systems in paste-paste form, the one component comprising zinc oxide and the other component comprising eugenol and colophony (abietic acid). The setting reaction here, just as in the case of the alginates, is a complexing reaction of the metal ions with the carboxylate groups. The metal ions in the zinc oxide-eugenol materials are additionally complexed by the two oxygen atoms at positions 1 and 2 of the aromatic ring of eugenol.
Similar setting mechanisms are shown by zinc phosphate and zinc polycarboxylate cements as well as glass ionomer cements, which are common materials in dentistry.

In the case of zinc phosphate and zinc polycarboxylate cements, a basic to amphoteric powder and an acidic aqueous solution form the starting components. In zinc phosphate cements, phosphoric acid is set with zinc oxide. The reaction between one part by weight of orthophosphoric acid and two parts by weight of zinc oxide thus leads to the crystalline reaction product hopeite, which is reached via intermediate phases of primary and secondary phosphates existing partly side by side. In practice, successful cleaning of dental instruments to remove contamination by zinc phosphate cements is particularly important. On the one hand zinc phosphate cement is a material which is employed very often, and on the other hand it is distinguished by a very high adhesiveness, which is why the removal of this material requires particular effort. In the case of zinc polycarboxylate cements, polyacrylic acid is set with zinc oxide. The dissolved zinc ions are complexed by the polyacrylic acid. The polymer chains are fixed electrostatically by incorporation of the zinc ions.
A similar reaction also takes place in glass ionomer cements. Here, glass powder is mixed with an aqueous solution of polyacrylic acid. Ions of the glass powder liberated by the attack by the acid react with the unsaturated polycarboxylic acid. The setting reaction leading to curing is based on the incorporation of metal ions of the glass into the polycarboxylic acid chains, which fix (complex) them electrostatically. As a result of the “acid-base” reaction, a hydrogel salt forms as the setting matrix. Under the influence of the metal ions, the polycarboxylic acid becomes solid and setting is initiated. Due to the increasing bonding of the metal ions to the polycarboxylic acid chains, curing of the cement occurs in a weakly exothermic reaction.
In practice, the abovementioned materials are often summarized under the term “acid-base cements”. In the dental field of work, there are therefore the systems of alginate, zinc oxide-eugenol, zinc phosphate and zinc polycarboxylate as well as glass ionomer called “acid-base cements”, which are all processed with dental instruments, such as impression trays and forceps.

In the prior art of cleaning of dental instruments, cured residues of “acid-base” cements adhering firmly to the surface of the instruments are cleaned with effort with the aid of concentrated cleaning solutions or cleaning powders if disposable instruments are not used.
The cleaning compositions conventionally used as a rule comprise a chelating agent suitable for complexing metal ions (ion-complexing compound, metal chelator), such as, for example, nitrilotriacetate (NTA), citric acid or EDTA. Aminocarboxylates (e.g. EDTA, NTA) in particular display their complexing action to the fullest extent at a pH of approx. 11 or above. The cleaning compositions of the prior art therefore as a rule have a correspondingly high pH.
However, impression trays are often made of aluminium, which corrodes at such highly alkaline pH values. To protect the material of instruments made of aluminium, as our own studies have now shown, the pH should therefore not be above 9.5, and should preferably be 8.5. However, the cleaning action of the cleaning compositions conventionally employed is low in this weakly alkaline pH range. A conflict of aims thus results when adjusting the pH of a cleaning composition which is also suitable for aluminium.

Several attempts have already been made to improve the cleaning of dental instruments, e.g. metallic impression trays, to remove “acid-base” cements. These proposals are often based on the attempt to cause the compounds formed in the setting reactions to undergo chemical degradation.
The document JP 61078706 discloses complete degradation of calcium alginate adhering to an impression tray by an aqueous solution of a certain concentration of sodium carbonate and hydrogen peroxide. Hydrogen peroxide is a potent oxidizing agent, the use of which requires special safety precautions and instructions for the persons handling it because of its caustic and fire-promoting properties. The use of such a potent oxidizing agent could also be unfavourable in respect of a possible corrosion of metallic instruments.

The document JP 07265335 discloses a steam treatment of an impression tray at 100° C. to 130° C. in order to clean the tray in this way to remove contaminating material within a short time. A disadvantage of this process, however, is obviously the high expenditure on apparatus.

The publication JP 08003588 describes a cleaning composition which is obtained by mixing a metal-chelating agent, such as EDTA, and an alkali metal salt of a diaminoethylglyerol derivative and which dissolves alginate without corroding the tray. JP 2003165997 describes a composition which comprises peroxyhydrates, such as sodium perborate and/or hydrogen peroxide, and an azole compound, such as benzothiazole. The tray-cleaning action is improved if at least one alkali metal salt chosen from the group consisting of carbonates, bicarbonates, phosphates, sulfates or hydrogen sulfates is added to the composition, such as e.g. sodium carbonate, sodium bicarbonate, sodium phosphate or sodium sulfate. The disadvantages associated with the use of hydrogen peroxide have already been mentioned above. In water, sodium perborate dissociates into hydrogen peroxide and sodium hydrogen borate. The latter compound passes through waste water treatment plants virtually unchanged and can thus enter the groundwater.

Reference may also be made to the following documents:
D1: WO 96/20737 A (UNIVERSITY OF MONTREAL; PREVOST, ANDRE; BARBEAU, JEAN; COTE, LUDGER; C) 11 Jul. 1996 (1996-07-11)
D2: WO 00/27438 A (UNIVERSITY OF MONTREAL; BARBEAU JEAN; GRAVEL, DENIS; HABI, ABDELKRIM) 18 May 2000 (2000-05-18)
D3: DE 198 14 829 A1 (MERZ+CO. GMBH &; CO. KG) 7 Oct. 1999 (1999-10-07)
D4: U.S. Pat. No. 4,129,456 A (LONGO ET AL) 12 Dec. 1978 (1978-12-12)
D5: EP 0 646 363 A (NIPPON SEIKI CO. LTD) 5 Apr. 1995 (1995-04-05)
D6: ANONYMOUS: “Method for the removal of excess cement in the manufacture of dental restorations” RESEARCH DISCLOSURE, MASON PUBLICATIONS, HAMPSHIRE, GB, vol. 461, no. 6 Sep. 2002 (2002-09), ISSN: 0374-4353

### SUMMARY OF THE INVENTION

The object of the present invention is to remedy the disadvantages of the prior art which have been described and to render possible a cleaning of dental instruments to remove contamination originating in particular from zinc phosphate cements which is more effective compared with the prior art, in particular at neutral to weakly alkaline pH values of from approx. 7.0 to 9.5. The cleaning should preferably be easier and/or faster to carry out compared with the prior art. Preferably, a cleaning composition to be provided should be widely usable, which means on the one hand that preferably it should be possible to clean every type of dental instrument, in particular one of aluminium, with this composition without damage, and on the other hand that preferably it should be also possible to remove other “acid-base” cements effectively, in addition to zinc phosphate cements.

According to a first aspect of the present invention, this object is achieved by a composition for cleaning dental instruments, comprising or (preferably) consisting of:
(a) one or more amino acids and/or salts thereof (aminocarboxylates) in a total amount of from 20 to 70 parts by weight, preferably 27.5 to 70 parts by weight,
(b) one or more alpha-hydroxy acids and/or salts thereof in a total amount of from 15 to 45 parts by weight,
(c) one or more alkali metal carbonates and/or bicarbonates in a total amount of from 0 to 50 parts by weight, if exclusively aminocarboxylates are employed preferably 0 to 40 parts by weight, particularly preferably 0 to 25 parts by weight, if exclusively amino acids are employed preferably 20 to 50 parts by weight,
(d) one or more surfactants in a total amount of from 0 to 5 parts by weight,
(e) one or more tabletting auxiliaries in a total amount of from 0 to 10 parts by weight,
(f) one or more corrosion inhibitors in a total amount of from 0 to 5 parts by weight, and
(g) one or more other additives in a total amount of from 0 to 55 parts by weight,
   wherein components (a), (b), (c), (d), (e), (f) and (g) are present in total in an amount of 100 parts by weight, and
   wherein the components are chosen such that the pH of a solution prepared by mixing the composition with 4,000 parts by weight of water is in the range of from 7.0 to 9.5, if exclusively aminocarboxylates are employed (that is to say in the absence of amino acids) preferably 7.5 to 9.5.

Water is not included here in the additives of component (g) of the composition.

The use of amino acids or alpha-hydroxy acids or salts thereof as chelating agents is indeed already known from the prior art. The invention is now based, however, on the surprising knowledge that on combination of amino acids (or salts thereof) and alpha-hydroxy acids (or salts thereof), a synergistic increase can be achieved in the cleaning power, that is to say the combination of these constituents can have a cleaning action which goes beyond mere addition of the cleaning actions of the individual components. This surprisingly effective cleaning action is achieved in particular at only neutral or weakly basic pH values (pH 7.0 to 9.5) compared with the prior art. In this pH range, dental instruments, in particular those of aluminium, are not corroded by the cleaning solution.

### BRIEF DESCRIPTION OF THE DRAWINGS

FIG. 1 is based on the results of Example 20 and plots the weight content of citric acid in the nitrilotriacetate/citric acid mixture is plotted on the x axis. 1 therefore means exclusively citric acid (corresponding to composition A), 0 means exclusively nitrilotriacetate (corresponding to composition E). The cleaning action standardized to the maximum value is plotted on the y axis. The synergistic intensification of the cleaning action is highest at a ratio of nitrilotriacetate:citric acid of 2:1.

### DETAILED DESCRIPTION OF THE INVENTION

The synergism effect on which the invention is based is not known from the prior art. The combination of amino acids (or salts thereof) and alpha-hydroxy acids (or salts thereof), in particular of nitrilotriacetate or nitrilotriacetic acid and citric acid or trisodium citrate, in a cleaning composition with which in particular dental instruments are to be freed from “acid-base” cement residues also is not known.

Precisely the use of amino acids, some of which have a very poor water-solubility, is not known in the connection according to the invention. Astonishingly, these compounds, which are poorly soluble in water, give very good results in respect of their rate of solution in water. Their rapid dissolution in water presumably takes place due to a neutralization of the acids by the metal carbonates and metal bicarbonates present in the mixture as component (c).

If (regularly sparingly soluble) amino acids are used, the storage stability of a corresponding composition according to the invention is comparatively high, presumably due to the lower hygroscopy of the amino acids in relation to the salts of the amino acids. In some preferred cases, component (a) comprises exclusively amino acids, that is to say no aminocarboxylates. In other cases, component (a) comprises exclusively aminocarboxylates.

WO 00/27438 A discloses certain compositions for removal of biofilms, but no compositions which comprise, in addition to comparatively large amounts of amino acid/carboxylate and alpha-hydroxy acid/salt, only 0-5 percent by weight of surfactants.

DE 196 03 977 teaches the use of a disinfection solution and a cleaning solution independent of this in a method for cleaning and disinfecting delicate medical equipment, in particular endoscopes. Since endoscopes are primarily contaminated with residues of human tissue and blood, the cleaning problem there is quite different to that of removal of “acid-base” cement residues from dental instruments. According to one embodiment, the disinfection solution disclosed comprises nitrilotriacetate and citric acid in equal contents by weight. A reason for the simultaneous use of the two substances is not given. In particular, no synergistic interaction is described. DE 196 03 977 discloses no composition having a pH in the range of from 7.0 to 9.5. The preferred pH ranges stated in this citation are below 7, in particular between 4.5 and 6.5. Since the pK value of the last protonation stage of citric acid is 6.4, the citric acid is present in monoprotonated form in a low pH range of this type, which is why it is to be expected that its chelating action would be impaired and there would no longer be a synergistic interaction with nitrilotriacetate in the removal of cement residues. The surprisingly high cleaning power of a composition according to the present invention allows the dental instruments to be cleaned at room temperature to remove “acid-base” cement residues, while DE 196 03 977 teaches a temperature range of from 55 to 65° C. for other contamination.

The patent specification DE 198 14 829 discloses a cleaning and disinfection composition for medical instruments, such as surgical instruments and anaesthesia material, in particular for endoscopy. It teaches the use of citric acid in an approximately three-fold weight excess over nitrilotriacetate. The role of the citric acid in adjusting the pH of the composition, which is between 1 and 5, is emphasized. No reason is given for the simultaneous use of citric acid and nitrilotriacetate. As already discussed above for DE 196 03 977, in the pH range and weight ratio of citric acid to nitrilotriacetate which are the teaching of DE 198 14 829, no synergistic intensification of the cleaning action of the two substances is to be expected if they were to be used on the unrelated cleaning problem of removal of cement residues from dental instruments. DE 198 14 829 moreover teaches working in the temperature range of from 50 to 70° C.

Compositions according to the first aspect of the present invention which are preferred are those in which the weight ratio of the total amount of amino acids and salts thereof to the total amount of alpha-hydroxy acids and salts thereof in the composition is greater than 1:1, preferably greater than 1.5:1, and in this context preferably less than 5:1, preferably less than 3:1. At these weight ratios, the synergistic intensification of the cleaning effect is surprisingly particularly high.

In preferred compositions according to the first aspect of the present invention, the amino acids of component (a) or salts thereof are chosen from the group consisting of nitrilotriacetate (NTA), ethylenediaminetetraacetate (EDTA), diethylenetriamine-pentaacetate, hydroxyethylethylenediaminetriacetate, methylglycine diacetate, acids thereof and the corresponding mixtures of acid(s) and/or salt(s). Nitrilotriacetate, nitrilotriacetic acid and mixtures thereof are particularly preferred.

Preferred compositions are furthermore those comprising alpha-hydroxy acids of component (b) and/or salts thereof which are chosen from the group consisting of glycolic acid (hydroxyacetic acid) and salts thereof (glycolates), lactic acid (2-hydroxypropanoic acid) and salts thereof (lactates), mandelic acid (hydroxyphenylacetic acid) and salts thereof (amygdalates), malic acid (hydroxysuccinic acid) and salts thereof (malates), tartaric acid (dihydroxysuccinic acid) and salts thereof (tartrates), citric acid (2-hydroxy-1,2,3-propanetricarboxylic acid) and salts thereof (citrates), and the corresponding mixtures of acid(s) and/or salt(s). Citric acid and/or salts thereof is particularly preferred.

As already mentioned, in the case of the joint use of amino acids and/or salts thereof, preferably nitrilotriacetic acid and/or nitrilotriacetate, and alpha-hydroxy acids and/or salts thereof, preferably citric acid and/or citrate, a surprisingly synergistically increased effectiveness can be achieved in the cleaning of dental instruments to remove “acid-base” cement residues.

A second aspect of the present invention therefore relates to a composition comprising or (preferably) consisting of
(a) nitrilotriacetic acid and/or nitrilotriacetate,
(b) citric acid and/or salts thereof,
(c) one or more alkali metal carbonates and/or bicarbonates in a total amount of from 0 to 50 parts by weight, if nitrilotriacetic acid is absent preferably 0 to 40 parts by weight, particularly preferably 0 to 25 parts by weight, if nitrilotriacetate is absent preferably 20 to 50 parts by weight,
(d) one or more surfactants in a total amount of from 0 to 5 parts by weight,
(e) one or more tabletting auxiliaries in a total amount of from 0 to 10 parts by weight,
(f) one or more corrosion inhibitors in a total amount of from 0 to 5 parts by weight and
(g) optionally one or more other additives,
   wherein components (a), (b), (c), (d), (e), (f) and (g) are present in total in an amount of 100 parts by weight, and
   wherein the weight ratio of the total amount of component (a) to the total amount of component (b) in the composition is greater than 1:1, preferably greater than 1.5:1, and in this context preferably less than 5:1, preferably less than 3:1.

Water is not included here in the additives of component (g) of the composition.

DE 198 14 829 A1 discloses no composition having a components ratio according to the invention.

It has already been pointed out that a pH in the neutral to weakly alkaline range of from 7.0 to 9.5 is preferred for a composition with which in particular aluminium instruments can be cleaned without the danger of corrosion. Preferably, the pH of a solution prepared by mixing the composition according to the second aspect of the present invention with 4,000 parts by weight of water is therefore in the range of from 7.0 to 9.5, if amino acids are absent preferably in the range of from 7.5 to 9.5.

The compositions according to the first and second aspect of the present invention, in particular in their embodiments described above and in the following as preferred, preferably comprise components such as surfactants, tabletting auxiliaries, corrosion inhibitors and/or other additives. Examples of preferred other additives are (further) buffer substances for adjusting and stabilizing the pH and further chelating agents.
A composition according to the first or second aspect of the present invention preferably comprises as component (f) an active amount in the range of from greater than 0 to not more than 5 parts by weight of one or more corrosion inhibitors. These are particularly desirable if metallic instruments of different redox potential are to be cleaned at the same time. A content of at least 0.1 part by weight of one or more corrosion inhibitors in a composition according to the invention is preferred for this. Above a certain amount, on the other hand, no further increase in the efficiency can be observed. For cost reasons, a maximum content of 4 parts by weight of corrosion inhibitors is therefore preferred.

These and all the following parts by weight stated in the description are in each case to be understood with the proviso that components (a), (b), (c), (d), (e), (f) and (g) are present in total in an amount of 100 parts by weight.
Examples of particularly active film-forming agents which can be employed as corrosion inhibitors are benzotriazole/tolyltriazole and/or alkylaminotriazole and their salts. The use of sodium phosphate or potassium phosphate, but-2-yne-1,4-diol, tetrapolyphosphoric acid methyl ester, aminotrimethylenephosphonic acid, hydroxyethane-1,1-diphosphonic acid, 2-phosphonobutane-1,2,4-tricarboxylic acid and alkali metal silicates is also preferred.

The adjustment of the pH with the aid of buffer substances in the form of or in addition to components (a) and (b), which can themselves be described as buffer substances, is of particular importance. As stated above, on the one hand it is known that ion-complexing compounds, such as aminocarboxylates (e.g. EDTA, NTA), display their complexing action to the fullest extent at a pH of approx. 11 or above, since complete deprotonation cannot be achieved at lower pH values. On the other hand, dental instruments, in particular also impression trays, are made of the most diverse metals, such as steel, aluminium, copper, nickel and the corresponding alloys. It was therefore extremely surprising to find that the compositions according to the invention achieved very much higher cleaning actions than conventional cleaning agents for “acid-base” cements from the prior art at pH values of not more than 9.5 in the removal of “acid-base” cement residues. They therefore can be employed as universal cleaning compositions, suitable for cleaning any type of metallic dental instruments. It was surprising to find that at pH values of less than or equal to 9.5, at which NTA is not completely deprotonated, a good cleaning of “acid-base” cement residues can be achieved. At the same time, aluminium instruments advantageously are not attacked. In principle, all the buffer substances which are suitable for use in the cleaning of dental instruments can be employed in compositions according to the first or second aspect of the present invention. However, in the absence of amino acids, the presence of from 10 to 25 parts by weight of one or more alkali metal carbonates and/or bicarbonates as component (c) in the compositions according to the first or second aspect of the present invention is particularly preferred.

Dissolving of a composition according to the invention results in a complex buffer system due to the interaction of all the buffer substances it contains. For example: Carbon dioxide and alkali metal carboxylates are formed by reaction of one or more alkali metal carbonates and/or bicarbonates (e.g. sodium carbonate, sodium bicarbonate, potassium carbonate, potassium bicarbonate or mixtures thereof) with an alpha-hydroxy acid. The resulting pH depends on the stoichiometric conversion of the educts. The alkali metal carbonate and/or bicarbonate and alpha-hydroxy acid system is a buffer system wherein the ratio between carbonate (and/or bicarbonate) and acid determines the pH. In the case where the composition is in the form of a solid (in this context, see below), the amount of these components determines their rate of solution in an aqueous solution. The aminocarboxylates of component (a), the alkali metal salts of which react as bases, likewise act as a buffer substance. Further constituents optionally contained in a composition according to the invention, for example fatty alcohol ethoxylates as surfactants and alkali metal salts of benzotriazole as corrosion inhibitors (see above), can likewise act as buffer substances.

The alpha-hydroxy acids or salts thereof of component (b) serve several primary purposes in the compositions according to the first and second aspect of the present invention, namely both (i) complexing of metal ions and therefore cleaning, and (ii) adjustment of the pH and (iii) if alkali metal carbonates and/or bicarbonates of component (c) are present, optionally the dissolving process of the composition. The amino acids or aminocarboxylates of component (a) serve for both (i) stable complexing of metal ions which are liberated during dissolving of the “acid-base” cement residues, and therefore cleaning, and (ii) adjustment of the pH and (iii) if amino acids are used, the dissolving process of the composition. It goes without saying that these purposes and, which is particularly important, a synergistic interaction of components (a) and (b) are to be taken into account when composing a composition according to the invention. The use of an amount of alkali metal carbonates and/or bicarbonates which is sufficient to achieve a virtually complete deprotonation of the alpha-hydroxy acid(s) or the amino acid(s) is preferred.
Suitable solvents for a composition according to the invention are, in addition to water, also aqueous solutions, in particular those which contain alcohols, such as, for example, methanol, ethanol, iso-propanol, n-propanol, iso-butanol, n-butanol, sec-butanol and/or tert-butanol.
Compositions according to the first or second aspect of the present invention which are in the form of a tablet, powder, granules or aqueous solution are preferred. A composition according to the invention which is in the form of a tablet is particularly preferred. Advantages of a tablet lie in particular in the simplified handling, since involved working steps, such as, for example, weighing or measuring of powders or concentrated cleaning solutions, can be dispensed with. This renders possible faster working and minimizes the risk of an undesirable contact with the cleaning composition, in particular breathing in of pulverulent substances. Furthermore, the preparation of cleaning solutions of constant composition is made easier.

The use of fizzy effervescent tablets for automatic cleaning of dental prostheses is known and is described, for example, in the patent specifications DE 695 32 420, DE 37 17 920, DE 38 88 503, DE 38 12 693, DE 100 54 693, DE 39 31 129, DE 42 00 002 and DE 39 34 390. The technical requirements of chemical/physical removal of contamination on dental prostheses based on plastic with the aid of a cleaning effervescent tablet or a cleaning effervescent powder are very different to those in the detachment of set residues of “acid-base” cement from dental instruments, such as metallic impression trays. While the compositions for cleaning dental prostheses primarily have to remove fatty residues of food and protein-containing and sparingly soluble mineral deposits from saliva from the prosthesis material of plastic, the active constituents of a composition for cleaning dental metallic instruments to remove solid “acid-base” cement residues must meet other requirements. In particular, the metal ions must be dissolved out of their complexes with the acids here, in order then to be able to break down the firm bond of the acids.
The simultaneous presence of one or more alkali metal carbonates and/or bicarbonates (as gas-forming substances, for example sodium carbonate, sodium bicarbonate, potassium carbonate and potassium bicarbonate) and an alpha-hydroxy acid and/or an amino acid in a composition according to the invention, e.g. tablet, is preferred and, in contact with water, leads to vigorous fizzing of the solution formed and an accelerated dissolving process of the composition. In the case of a composition according to the invention in the form of a tablet, if one or more alkali metal carbonates and/or bicarbonates are present the alpha-hydroxy acids and/or amino acids present in the compositions according to the invention also serve as disintegrating agents.
A composition according to the invention in tablet form can contain one or more tabletting auxiliaries, depending on the size of the tablet. These serve, inter alia, as binders for adhesion of the individual components in tablet form. In the case of small tablets, small amounts of or even no tabletting auxiliaries are required, in the case of larger tablets disproportionately more. A content of from 1 to 10 parts by weight of one or more tabletting auxiliaries as component (e) of a composition according to the invention in tablet form is preferred. The following lists indicate suitable tabletting auxiliaries, which can be fillers, dry binders, binders for granulation, slip agents and lubricants, individual or several of which can be employed. Lactose, sucrose, mannitol, glycine, leucine, sorbitol, microcrystalline cellulose, starch, dicalcium phosphate and polyglycols can be used as fillers and dry binders. Suitable binders for the granulation are starch, alginates, polyvinylpyrrolidone and, in particular, carboxymethylcellulose. Starch, talc, silicon dioxide, magnesium stearate and similar metal soaps e.g. can be used as slip agents and lubricants. A composition according to the first or second aspect of the present invention which is very particularly preferred is one which is in the form of a tablet and comprises or preferably consists of:
(a) nitrilotriacetic acid, nitrilotriacetate or a mixture thereof in a total amount of from 20 to 70 parts by weight, preferably 30 to 70 parts by weight,
(b) citric acid, salts thereof or a mixture of citric acids and salts thereof in a total amount of from 15 to 45 parts by weight,
(c) one or more alkali metal carbonates and/or bicarbonates in a total amount of from 10 to 50 parts by weight, preferably if nitrilotriacetic acid is absent 10 to 25 parts by weight and if nitrilotriacetate is absent preferably 20 to 50 parts by weight,
(d) one or more surfactants in a total amount of from 0 to 5 parts by weight,
(e) one or more tabletting auxiliaries in a total amount of from 1 to 10 parts by weight,
(f) one or more corrosion inhibitors in a total amount of from 0.1 to 4 parts by weight, and
(g) optionally one or more other additives,
   wherein components (a), (b), (c), (d), (e), (f) and (g) are present in total in an amount of 100 parts by weight,
   wherein the weight ratio of the total amount of nitrilotriacetic acid and nitrilotriacetate to the total amount of citric acid and its salts in the composition is greater than 1:1, preferably greater than 1.5:1 and

wherein the components are chosen such that the pH of a solution prepared by mixing the composition with 4,000 parts by weight of water is in the range of from 7.0 to 9.5, if nitrilotriacetic acid is absent preferably in the range of from 7.5 to 9.5.

Preferably, in this context the weight ratio of the total amount of nitrilotriacetic acid and nitrilotriacetate to the total amount of citric acid and its salts in the composition is less than 5:1, preferably less than 3:1.

It should be expressly pointed out once again that water is not included here in the additives of component (g) of the composition. However, in addition to components (a), (b), (c), (d), (e), (f) and (g), the composition can comprise further components, in particular water. In this case also, there is the proviso that the pH of a solution prepared by mixing such a composition with 4,000 parts by weight of water is in the range of from 7.0 to 9.5.

Particularly preferred compositions are the following compositions (A) and (B) in the form of tablets comprising or consisting of:

(A)

(a) sodium nitrilotriacetate in a total amount of from 24 to 54 parts by weight, preferably 44 to 54 parts by weight,
(b) citric acid, salts of citric acid or a mixture of citric acid and salts thereof in a total amount of from 22.5 to 26.5 parts by weight, preferably citric acid by itself,
(c) sodium carbonate in a total amount of from 18 to 22 parts by weight,
(d) C₁₆C₁₈-fatty alcohol ethoxylates in a total amount of from 0.45 to 0.55 parts by weight,
(e) polyethylene glycol 6000 in a total amount of from 4.5 to 5.5 parts by weight,
(f) 5-methylbenzotriazole-sodium in a total amount of from 0.9 to 1.1 parts by weight,
   (B)
(a) nitrilotriacetic acid in a total amount of from 24 to 54 parts by weight, preferably 34 to 44 parts by weight,
(b) citric acid, salts of citric acid or a mixture of citric acid and salts thereof in a total amount of from 19.2 to 23.2 parts by weight, preferably citric acid by itself,
(c) sodium carbonate in a total amount of from 32.5 to 36.5 parts by weight,
(d) C₁₆C₁₈-fatty alcohol ethoxylates in a total amount of from 0.45 to 0.55 parts by weight,
(e) polyethylene glycol 6000 in a total amount of from 4.5 to 5.5 parts by weight,
(f) 5-methylbenzotriazole-sodium in a total amount of from 0.9 to 1.1 parts by weight.
   The compositions according to the first or second aspect of the present invention can comprise one or more surfactants. The surfactants can deposit themselves between the various phases of the system to be cleaned and reduce the surface tension of the water at the “dental instrument”/“acid-base” cement residue interface.
   Nonionic surfactants have high dipole moments in aqueous solution and are highly hydrated. Examples of nonionic surfactants are alkylene oxide adducts, such as can be obtained by addition of ethylene oxide and/or propylene oxide on to fatty alcohols, fatty acids, fatty acid glycerides, phenols, fatty amines and alkylphenols, it also being possible for the terminal hydroxyl groups of these polyglycol ether derivatives to be etherified, esterified or acetalized.
   The following are suitable in particular
   addition products of ethylene oxide in the molar ratio of from 2- to 50-fold and/or of propylene oxide in the molar ratio of from 1- to 5-fold on linear and branched fatty alcohols having 8 to 30 C atoms, on fatty acids having 8 to 30 C atoms and on alkylphenols having 8 to 15 C atoms in the alkyl chain,
   addition products of ethylene oxide in the molar ratio of from 1- to 30-fold on glycerol,
   addition products of ethylene oxide in the molar ratio of from 5- to 60-fold on castor oil or hydrogenated castor oil,
   polyol fatty acid esters,
   alkoxylated triglycerides,
   amine oxides, such as N-cocoalkyl-N,N-dimethylamine oxide or N-tallow alkyl-N,N-dihydroxyethylamine oxide,
   esters of sorbitan and one, two or three fatty acids having 8 to 22 C atoms and a degree of ethoxylation of from 4 to 20,
   fatty acid sugar esters, in particular esters of sucrose and one or two fatty acids having 8 to 22 C atoms, for example sucrose cocoate, sucrose dilaurate, sucrose distearate, sucrose laurate, sucrose myristate, sucrose oleate, sucrose palmitate, sucrose stearate, sucrose ricinoleate etc.,
   alkyl and alkenyl oligoglycosides,
   addition products of ethylene oxide on fatty acid alkanolamides and fatty amines, and
   addition products of ethylene oxide on sugar fatty acid esters.
   Anionic surfactants consist of a hydrophobic radical and a negatively charged hydrophilic head group, which renders the surfactant water-soluble. Suitable groups are, for example, carboxylate, sulfate, sulfonate or phosphate groups, which are then bonded to lipophilic alkyl groups having, for example, 8 to 30 C atoms. In addition, the compound can contain glycol or polyglycol ether groups, ester, ether and amide groups and hydroxyl groups.
   Examples of suitable anionic surfactants are salts and esters of carboxylic acids, alkyl ether-sulfates, alkyl sulfates, fatty alcohol ether-sulfates, sulfonic acids and their salts, phosphoric acid esters and their salts and acylamino acids and their salts.
   An aspect of the chelating agents which bond metal ions contained in the compositions according to the invention which is important in this connection is that of bonding metal ions introduced into the solution if hard water is used, in particular calcium ions. The formation of sparingly soluble salts can thus be prevented with the anionic surfactants and the cleaning action thereof can therefore be maintained. In addition to the formation of stable complexes with the metal ions from the products of the neutralization of the cement reaction, it is therefore advantageous to eliminate the salts present, since salt-containing water makes the cleaning operation difficult and restricts the activity of the surfactants.
   Amphoteric surfactants carry both a negative and a compensating positive charge.
   Examples of amphoteric surfactants are the derivatives of tertiary aliphatic amines and quaternary aliphatic ammonium compounds, the aliphatic radicals of which can be straight-chain or branched and one of which carries a carboxyl, sulfo, phosphono, sulfato or phosphato group, such as, for example, N,N-dimethyl-N-tetradecylglycine, N,N-dimethyl-N-hexadecylglycine, N,N-dimethyl-N-octadecylglycine or 3-(N,N-dimethyl-N-dodecylammonium) 1-propanesulfonate.
   Further amphoteric surfactants are the betaines. Examples of these include the
   alkylbetaines having 8 to 18 C atoms, such as cocodimethylcarboxymethylbetaine,
   lauryldimethylcarboxymethylbetaine, lauryldimethylcarboxyethylbetaine, cetyl-dimethylcarboxymethylbetaine, oleyldimethylgammacarboxypropylbetaine and laurylbis(2-hydroxypropyl)alphacarboxyethylbetaine,
   sulfobetaines having 8 to 18 C atoms, such as cocodimethylsulfopropylbetaine, stearyldimethylsulfopropylbetaine, lauryldimethylsulfoethylbetaine and laurylbis(2-hydroxyethyl)sulfopropylbetaine,
   carboxy derivatives of imidazole,
   alkyldimethylammonium acetates having 8 to 18 C atoms,
   alkyldimethylcarbonylmethylammonium salts having 8 to 18 C atoms, and
   fatty acid alkylamidobetaines having 8 to 18 C atoms.
   Cationic surfactants consist of a hydrophobic radical and a positively charged hydrophilic head group, which renders the surfactant water-soluble. The positively charged atom is as a rule a nitrogen atom, to which four groups independent of one another are bonded. These groups can be aliphatic or aromatic, and they can be alkoxy groups, polyoxyalkylene groups, alkylamino groups, hydroxyalkyl groups, aryl groups or alkaryl groups having 1 to 22 C atoms, at least one radical having at least 6, better still 8 C atoms. The positively charged nitrogen atom must be neutralized by an anion, for example a halogen, an acetate, a phosphate, a nitrate or an alkyl sulfate.
   Examples of cationic surfactants are quaternary ammonium compounds, such as ammonium halides, in particular chlorides and bromides, that is to say alkyltrimethylammonium chloride, dialkyldimethylammonium chloride and trialkylmethylammonium chloride, such as cetyltrimethylammonium chloride, stearyltrimethylammonium chloride, distearyldimethylammonium chloride, lauryldimethylammonium chloride, lauryldimethylbenzylammonium chloride and tricetylmethylammonium chloride, and the corresponding bromides.
   Alkylpyridinium salts, such as lauryl- or cetylpyridinium salts, or compounds which contain both at least one ester function and at least one quaternary ammonium group as a structural element, for example quaternized ester salts of fatty acids with triethanolamine, quaternized ester salts of fatty acids with diethanolalkylamines or quaternized ester salts of fatty acids with 1,2-dihydroxypropyldialkylamine, are furthermore suitable.
   Alkylamidoamines, which can be prepared by amidation of fatty acids with dialkylaminoamines, are likewise suitable.

Mixtures of the abovementioned surfactants can also be used. The nonionic surfactants are preferably employed because of their low tendency towards foaming, which facilitates handling.
As stated, a synergistic intensification of the cleaning action on “acid-base” cement residues can be observed by combination of chelating agents from the group consisting of aminocarboxylates with chelating agents from the group consisting of alpha-hydroxy acids. Examples of chelating agents which can generally be employed in compositions according to the first or second aspect of the present invention are firstly the aminocarboxylates (e.g. nitrilotriacetate (NTA), ethylenediaminetetraacetate (EDTA), diethylenetriaminepentaacetate, hydroxyethylethylenediaminetriacetate and methylglycine diacetate) and acids thereof of component (a) and the alpha-hydroxy acids (e.g. glycolic acid, lactic acid, mandelic acid, malic acid, tartaric acid, citric acid) and salts thereof of component (b). Further chelating agents can moreover be employed as (constituents of) component (g). These include tetrakis(−2-hydroxypropyl)ethylenediamine, 1-hydroxyethane-1,1-diphosphonic acid, aminotris(methylenephosphonic acid), ethylenediaminetetrakis(methylenephosphonic acid), phosphonobutanetricarboxylic acid, gluconic acid, adipic acid, fumaric acid, succinic acid and salts thereof, as well as mixtures of the acids and salts thereof. Examples of further suitable chelating agents include sodium polyphosphate, acid sodium pyrophosphate and tetrasodium pyrophosphate. Polycarboxylic acids and polymeric polycarboxylates, such as, for example, the metal salts of polyacrylic acid or of polymethacrylic acid, are likewise suitable. These also include copolymeric polycarboxylic acids and copolymeric polycarboxylates, such as copolymers of acrylic acid with maleic acid or copolymers of acrylic acid with methacrylic acid. These compounds can additionally also be modified with allylsulfonic acids, such as, for example, with allyloxybenzenesulfonic acid or methallylsulfonic acid. Other copolymers contain acrolein and acrylic acid or acrolein and vinyl acetate as structural elements.

Apart from removal of “acid-base” cements, compositions according to the first or second aspect of the present invention are also suitable for removal of adhesive lacquer from dental instruments. A composition according to the invention is also particularly suitable for cleaning so-called joiner's trays. These trays are made of chromed zinc, which is brought into its shape by a pressure casting process. Such materials are often easily corroded, since microcracks can easily occur in the chromium layer applied. This is largely suppressed by the pH range of a cleaning liquid comprising a composition according to the invention and the corrosion inhibitors preferably used. Apart from cleaning of metallic dental instruments, the compositions according to the invention are of course also suitable for cleaning instruments of plastic.
Due to the high cleaning action of the compositions according to the invention, ultrasonic treatment of the instruments to be cleaned is not necessary. However, the cleaning solutions can be employed in an ultrasonic bath without problems.

It is moreover an advantage of the compositions according to the invention that they are biodegradable and are protective on materials according to OECD guidelines.

According to a third aspect, the present invention also relates to a process for the preparation of an aqueous cleaning liquid for dental instruments, comprising the following step:
preparation of a mixture comprising a preferably dissolved composition according to the invention, wherein components (a), (b), (c), (d), (e), (f) and (g) are present in an amount of 100 parts by weight in total and water is present in an amount of not more than 10,000, preferably 2,000 to 6,000 parts by weight.

An example of this is the dissolving of a composition according to the invention in the form of a tablet in water or an aqueous solution.

According to a fourth aspect, the present invention furthermore relates to an aqueous cleaning liquid for dental instruments, comprising
a dissolved or dispersed composition according to the invention, wherein components (a), (b), (c), (d), (e), (f) and (g) are present in an amount of 100 parts by weight in total, and
water in an amount of not more than 10,000, preferably 2,000 to 6,000 parts by weight.
A further aspect of the present invention relates to the use of citric acid and/or salts thereof for the synergistic intensification of the action of nitrilotriacetate, nitrilotriacetic acid or a mixture thereof in removing “acid-base” cement residues. A closely related aspect also relates to the use of nitrilotriacetate, nitrilotriacetic acid or a mixture thereof for the synergistic intensification of the action of citric acid and/or salts thereof in removing “acid-base” cement residues.
Further aspects of the invention emerge from the attached patent claims and the following examples.
The examples are intended to illustrate the present invention without limiting it.

### EXAMPLES 1 TO 16

### Compositions for Cleaning Dental Instruments

| | Example: | | | | | | | | | | | | |
|---|---|---|---|---|---|---|---|---|---|---|---|---|---|
| | 1 | 2 | 3 | 4* | 5* | 6* | 7* | 8* | 9* | 10* | 11* | 12 | 13 |
| Nitrilotriacetate | 12 | 11 | 14 | 28 | 28 | 48.5 | 28 | 41 | 48.5 | 48.5 | 50 | 60 | 70 |
| (pt. by wt.) | | | | | | | | | | | | | |
| Citric acid | 28.5 | 25.5 | 33 | 30 | 30 | 25 | 30 | 19 | 25 | 25 | 15 | 10 | 10 |
| (pt. by wt.) | | | | | | | | | | | | | |
| Sodium | 17 | 30 | 4.9 | | | 20 | | 12 | 20 | 20 | | 15 | |
| carbonate | | | | | | | | | | | | | |
| (pt. by wt.) | | | | | | | | | | | | | |
| Sodium | 39 | 33.5 | 43.6 | 39 | 39 | | 39 | 25 | | | 20 | | 13 |
| bicarbonate | | | | | | | | | | | | | |
| (pt. by wt.) | | | | | | | | | | | | | |
| C₁₆C₁₈-fatty | | 0 | 4.5 | | | 0.5 | | | 0.5 | 0.5 | 2 | | |
| alcohol | | | | | | | | | | | | | |
| ethoxylates | | | | | | | | | | | | | |
| (pt. by wt.) | | | | | | | | | | | | | |
| Na fatty alcohol | 2.5 | | | 0 | 0 | | 1.5 | | | 3 | 2 | | |
| sulfate | | | | | | | | | | | | | |
| (pt. by wt.) | | | | | | | | | | | | | |
| Polyethylene | | 0 | | 1.5 | 3 | 5 | 1.5 | 2.6 | 3 | 0 | 3 | | |
| glycol 6000 | | | | | | | | | | | | | |
| (pt. by wt.) | | | | | | | | | | | | | |
| Starch | | | | 1.5 | | | | | | | | | |
| (pt. by wt.) | | | | | | | | | | | | | |
| 5-Methyl- | 1 | | | | | 1 | | | 3 | 1.5 | | | |
| benzotriazole- | | | | | | | | | | | | | |
| sodium | | | | | | | | | | | | | |
| (pt. by wt.) | | | | | | | | | | | | | |
| Benzotriazole- | | | | | | | | | | 1.5 | | | |
| Na (pt. by wt.) | | | | | | | | | | | | | |
| NaH₂PO₄, | | | 0 | | | | 0 | 0.4 | | | 8 | 15 | 7 |
| Na₂HPO₄ | | | | | | | | | | | | | |
| (pt. by wt.) | | | | | | | | | | | | | |
| pH after mixing | 9 | 9 | 7.5 | 9.5 | 9.5 | 8.5 | 9.5 | 9 | 8.5 | 8.5 | 9 | 10 | 9.5 |
| with 4,000 pt. by | | | | | | | | | | | | | |
| wt. of water | | | | | | | | | | | | | |
| pH after mixing | 9.2 | 9.1 | 7.4 | 9.4 | 9.5 | 8.5 | 9.5 | 9.1 | 8.4 | 8.6 | 9.1 | 10.1 | 9.4 |
| with 2,000 pt. by | | | | | | | | | | | | | |
| wt. of water | | | | | | | | | | | | | |
| pH after mixing | 8.5 | 8.5 | 7.3 | 9.2 | 9.2 | 8.2 | 9.1 | 8.7 | 8.1 | 8.1 | 8.7 | 9.6 | 9.0 |
| with 10,000 pt. | | | | | | | | | | | | | |
| by wt. of water | | | | | | | | | | | | | |

| | Example: | | |
|---|---|---|---|
| | 14* | 15* | 16* |
| Nitrilotriacetic acid | 30 | 24 | 39 |
| (pt. by wt.) | | | |
| Trisodium citrate | 20.1 | 16 | 21.2 |
| (pt. by wt.) | | | |
| Sodium carbonate | 43.4 | 34 | 34.5 |
| (pt. by wt.) | | | |
| Na diimidosuccinate | 0 | 19.5 | |
| (pt. by wt.) | | | |
| C₁₆C₁₈-fatty alcohol | 0.5 | 0.5 | 0.5 |
| ethoxylates (pt. by wt.) | | | |
| Na fatty alcohol sulfate | 0 | 0 | 0 |
| (pt. by wt.) | | | |
| Polyethylene glycol | 5 | 5 | 5 |
| 6000 (pt. by wt.) | | | |
| Starch (pt. by wt.) | | | |
| 5-Methylbenzotriazole- | 1 | 1 | 1 |
| sodium (pt. by wt.) | | | |
| Benzotriazole-Na | | | |
| (pt. by wt.) | | | |
| NaH₂PO₄, Na₂HPO₄ | | | 0 |
| (pt. by wt.) | | | |
| pH after mixing with | 7.0 | 7.7 | 7.5 |
| 4,000 pt. by wt. of water | | | |
| pH after mixing with | 7.6 | 7.9 | 7.4 |
| 2,000 pt. by wt. of water | | | |
| pH after mixing with | 7.1 | 7.4 | 7.3 |
| 10,000 pt. by wt. of | | | |
| water | | | |

pt. by wt. = parts by weight

Examples 4, 5, 6, 7, 8, 9, 10, 11, 14, 15 and 16 labelled with an asterisk * are examples according to the invention, Examples 1, 2, 3, 12 and 13 are comparison examples.

In each Example 1 to 16, the sum of the parts by weight (pt. by wt.) is 100.

The compositions were in each case in the form of a solid (powder).
The solutions prepared by mixing the compositions with the said number of parts by weight of water had the pH values stated.

### EXAMPLE 17

### Tablet

A composition according to Example 6 was prepared as a tablet. For this, the thoroughly mixed constituents were introduced into a steel cylinder (diameter 40 mm, height 60 mm) and pressed by means of a die. By means of a hydraulic system, a weight of 3 t acted on the die.
A composition according to Example 16 was prepared as a tablet in an analogous manner.

### EXAMPLE 18

### Method for Quantitative Determination of a Cleaning Action (cf. also Examples 19, 20 and 21)

For each cleaning solution to be investigated, identical disc-shaped test specimens (diameter 2 cm +/−0.2 mm, thickness 2 mm +/−0.1 mm) of a certain cement (see below and Examples 19, 20 and 21) were produced and weighed. Aqueous cleaning solutions (see Examples 19, 20 and 21) were prepared by dissolving in each case 100 parts by weight of certain compositions in 4,000 parts by weight of water. The identical test specimens were in each case suspended by means of a net (mesh width 500 μm) in 250 ml of the particular aqueous cleaning solution (20° C.).
After the test specimens had been immersed in the particular solution for 3 h (e.g. alginate, zinc polycarboxylate) or 8 h (e.g. zinc phosphate), the solution was sucked off through a tared glass frit and the residue was washed three times with 20 ml of water each time, dried to constant weight at 150° C. and weighed. The weight of the particular residue divided by the weight, in each case identical, of the test specimen employed is a measure of the cleaning action. It is noted that in these experiments only the water-insoluble material resulting from the fillers which has settled out at the bottom of the solution is taken into account for determination of the cleaning efficiency.

### EXAMPLE 19

### Aqueous Cleaning Liquids

Aqueous cleaning liquids for dental instruments were prepared by mixing compositions according to Examples 1 to 16 and Example 17 (tablet) with 4,000 pt. by wt. of water.
19.1: The cleaning actions of cleaning liquids based on all the compositions according to Example 1 to 16 were quantified against in each case identical test specimens of zinc phosphate cement. The method from Example 18 was used for this. It was found that cleaning liquids corresponding to Examples 4 to 11 and 14 to 16 according to the invention were superior to cleaning liquids corresponding to Comparison Examples 1 to 3 and 12 to 13. It was furthermore found that the presence or absence of carbonates or bicarbonates resulted in no significant difference in the cleaning action; the amounts of nitrilotriacetate and citric acid were decisive.
19.2: The cleaning actions of cleaning liquids based on Examples 4 to 11 and 14 to 16 according to the invention were tested against alginate (demedis), zinc phosphate cement (Poscal, VOCO) and zinc polycarboxylate cements (Carboco, VOCO). The cements were in each case prepared according to the manufacturer's instructions. Aluminium impression trays were coated uniformly with in each case 10 g of alginate impression composition. Dental instruments were coated uniformly with in each case 1 g of zinc phosphate cement or in each case 1 g of zinc polycarboxylate cement. After the setting reaction had proceeded to completion, the impression trays and instruments contaminated in the said manner were incubated in the aqueous cleaning liquids for 6 h at 20° C. and then rinsed off under running cold water. The contamination was removed completely by this procedure in all cases. No indications of corrosion of the trays were found on examination under the microscope.

### EXAMPLE 20

### Synergistic Effect

Compositions A, B, C, D and E according to the following table were prepared and in each case dissolved in 4,000 parts by weight (pt. by wt.) of water at 20° C. The pH was then adjusted to in each case 8.5 with HCl or NaOH.

| | Composition: | | | | |
|---|---|---|---|---|---|
| | A | B | C* | D* | E |
| Nitrilotriacetate (pt. by wt.) | 0 | 40 | 67 | 80 | 100 |
| Citric acid (pt. by wt.) | 100 | 60 | 33 | 20 | 0 |
| pH after mixing with 4,000 | 8.5^{#} | 8.5^{#} | 8.5^{#} | 8.5^{#} | 8.5^{#} |
| pt. by wt. of water | | | | | |

^{#}pH adjusted with HCl or NaOH
pt. by wt. = parts by weight

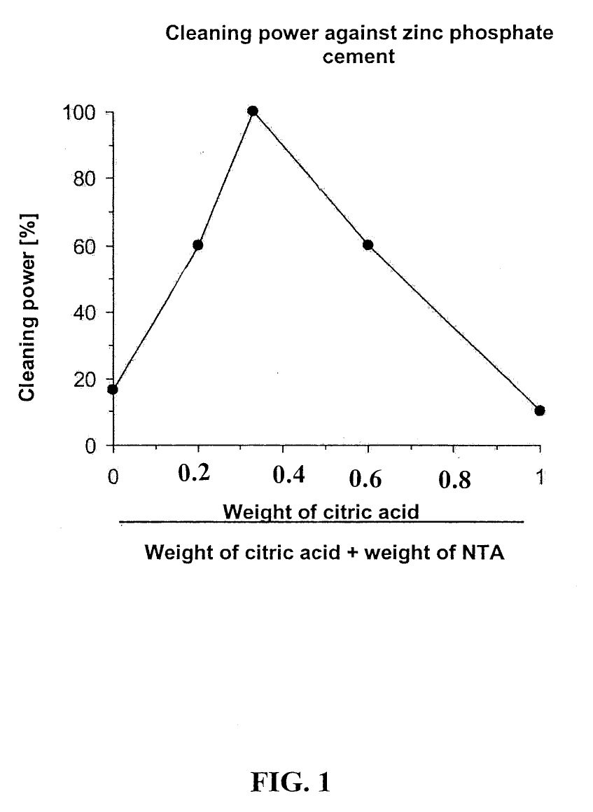

Examples C and D labelled with an asterisk * are examples according to the invention, Examples A, B and E are comparison examples.
The cleaning action of the various solutions was determined against in each case identical test specimens of zinc phosphate cement (Poscal, VOCO) in accordance with Example 18.
At a weight content of citric acid of 0.33 (composition C), the cleaning power of the composition was approx. 6× higher than with the exclusive use of NTA (composition E) and approx. 10× higher than with the exclusive use of citric acid (composition A). This synergistic intensification of the cleaning power with the combination of the chelating agents NTA and citric acid can also be demonstrated with the aid of Kull's equation (Kull et al (1961) Appl Microbiol 9, 538). FIG. 1 illustrates the results.
Description of FIG. 1:

The weight content of citric acid in the nitrilotriacetate/citric acid mixture is plotted on the x axis. 1 therefore means exclusively citric acid (corresponding to composition A), 0 means exclusively nitrilotriacetate (corresponding to composition E). The cleaning action standardized to the maximum value is plotted on the y axis. The synergistic intensification of the cleaning action is highest at a ratio of nitrilotriacetate:citric acid of 2:1.

### EXAMPLE 21

### Comparison with Cleaning Agents from the Prior Art

The cleaning action of a solution of the tabletted composition from Example 17, prepared by mixing with 4,000 pt. by wt. of water, was compared with three conventional cleaning compositions for acid-base cements from the prior art. In accordance with Example 18, in each case identical test specimens of zinc phosphate cement (Poscal, VOCO) and alginate (demedis) were produced and the cleaning actions were quantified.

The cleaning compositions of the prior art (I, II and III) had the following compositions according to our own analyses (comparison examples):

| | | | | | | Other |
|---|---|---|---|---|---|---|
| | NTA | EDTA | Surfactants | Soda | Polyphosphate | constituents |
| Product | (pt. by wt.) | (pt. by wt.) | (pt. by wt.) | (pt. by wt.) | (pt. by wt.) | (pt. by wt.)* |
| I | | | | 50 | 50 | 0 |
| II | | 10-15 | | | | to 100 |
| III | 5-15 | | 6-20 | | | to 100 |

pt. by wt. = parts by weight

a) Conditions Corresponding to the Manufacturer's Instructions
In accordance with the manufacturer's instructions, solutions were prepared by mixing product I with 1,250 pt. by wt. of water and product III with 5,000 pt. by wt. of water. Product II was already in the form of a solution and was employed in undiluted form. These solutions had the pH values stated in the following table (standard pH values).

A comparison of their cleaning action under these conditions with the cleaning action of the dissolved composition according to the invention produced the following result:

| | | Relative cleaning | Relative cleaning |
|---|---|---|---|
| | | action | action |
| Product | pH | alginate | zinc phosphate |
| I | 11 | 28.8 | 0.3 |
| II | 8.5 | 0.2 | 10.3 |
| III | 12 | 11.9 | 0.7 |
| according to | 8.5 | 100 | 100 |
| Example 17 | | | |

The cleaning actions in this context are standardized to the cleaning action of the dissolved composition according to the invention (cleaning action 100).

The cleaning actions of the cleaning compositions from the prior art under conditions corresponding to the manufacturer's instructions (pH, active substance concentrations in solution) were lower than that of the dissolved composition according to the invention.

b) Standardized Conditions

The products of the prior art (I and III) in the form of a solid were mixed with water in the same ratio as the composition according to the invention of Example 17 (in each case 100 pt. by wt. of product with 4,000 pt. by wt. of water). Product II, in the form of a solution, was employed in undiluted form and therefore contained a comparatively high concentration of EDTA. Solutions of products I and III were adjusted by addition of HCl to the same pH as the solution which results when the composition according to the invention is dissolved (pH 8.5).

| | | Relative cleaning | Relative cleaning |
|---|---|---|---|
| | | action | action |
| Product | pH | alginate | zinc phosphate |
| I | 8.5 | 53.6 | 4.5 |
| II | 8.5 | 0.2 | 10.3 |
| III | 8.5 | 5.13 | 4.1 |
| according to | 8.5 | 100 | 100 |
| Example 17 | | | |

The cleaning actions in this context are standardized to the cleaning action of the dissolved composition according to the invention (cleaning action 100).
The cleaning actions of products I to III (prior art) at pH 8.5 were weaker than that of the dissolved composition according to the invention.

1. A composition for cleaning dental instruments, comprising or consisting of:
(a) one or more amino acids and/or salts thereof (aminocarboxylates) in a total amount of from 20 to 70 parts by weight, preferably 27.5 to 70 parts by weight,
(b) one or more alpha-hydroxy acids and/or salts thereof in a total amount of from 15 to 45 parts by weight,
(c) one or more alkali metal carbonates and/or bicarbonates in a total amount of from 0 to 50 parts by weight,
(d) one or more surfactants in a total amount of from 0 to 5 parts by weight,
(e) one or more tabletting auxiliaries in a total amount of from 0 to 10 parts by weight,
(f) one or more corrosion inhibitors in a total amount of from 0 to 5 parts by weight, and
(g) one or more other additives in a total amount of from 0 to 55 parts by weight,
wherein components (a), (b), (c), (d), (e), (f) and (g) are present in total in an amount of 100 parts by weight, and
wherein the components are chosen such that the pH of a solution prepared by mixing the composition with 4,000 parts by weight of water is in the range of from 7.0 to 9.5.

2. A composition according to claim 1, wherein the weight ratio of the total amount of amino acids and/or salts thereof to the total amount of alpha-hydroxy acids and salts thereof in the composition is greater than 1:1, preferably greater than 1.5:1.

3. A composition according to claim 1, wherein the aminocarboxylates of component (a) are chosen from the group consisting of:
nitrilotriacetate, ethylenediaminetetraacetate, diethylenetriaminepentaacetate, hydroxyethylethylenediaminetriacetate, methylglycine diacetate, acids thereof and mixtures thereof.

4. A composition according to claim 1, wherein the alpha-hydroxy acids and salts thereof of component (b) are chosen from the group consisting of:
glycolic acid, lactic acid, mandelic acid, malic acid, tartaric acid, citric acid and salts thereof,
and mixtures thereof.

5. A composition according to claim 1, wherein
component (a) comprises nitrilotriacetic acid and/or nitrilotriacetate, and
component (b) comprises citric acid and/or salts thereof,
wherein the weight ratio of the total amount of component (a) to the total amount of component (b) in the composition is greater than 1:1, preferably greater than 1.5:1.

6. A composition according to claim 5, wherein the components are chosen such that the pH of a solution prepared by mixing the composition with 4,000 parts by weight of water is in the range of from 7.0 to 9.5.

7. A composition according to claim 1, comprising as component (f) 0.1 to 4 parts by weight of one or more corrosion inhibitors.

8. A composition according to claim 1, comprising as component (c) 10 to 25 parts by weight of one or more alkali metal carbonates and/or bicarbonates.

9. A composition according to claim 1, wherein the composition is in the form of a tablet, powder, granules or aqueous solution.

10. A composition according to claim 1, wherein the composition is in the form of a tablet and comprises as component (e) 1 to 10 parts by weight of one or more tabletting auxiliaries.

11. A composition according to claim 1 in the form of a tablet, comprising:
(a) nitrilotriacetic acid, nitrilotriacetate or a mixture thereof in a total amount of from 20 to 70 parts by weight, preferably 30 to 70 parts by weight,
(b) citric acid, salts thereof or a mixture of citric acids and salts thereof in a total amount of from 15 to 45 parts by weight,
(c) one or more alkali metal carbonates and/or bicarbonates in a total amount of from 10 to 50 parts by weight,
(d) one or more surfactants in a total amount of from 0 to 5 parts by weight,
(e) one or more tabletting auxiliaries in a total amount of from 1 to 10 parts by weight,
(f) one or more corrosion inhibitors in a total amount of from 0.1 to 4 parts by weight, and
(g) optionally one or more other additives,
wherein components (a), (b), (c), (d), (e), (f) and (g) are present in total in an amount of 100 parts by weight, and
wherein the weight ratio of the total amount of nitrilotriacetate and nitrilotriacetic acid to the total amount of citric acid and its salts in the composition is greater than 1:1, preferably greater than 1.5:1, and
wherein the components are chosen such that the pH of a solution prepared by mixing the composition with 4,000 parts by weight of water is in the range of from 7.0 to 9.5.

12. A composition according to claim 1, comprising:
(A)
(a) sodium nitrilotriacetate in a total amount of from 24 to 54 parts by weight, preferably 44 to 54 parts by weight,
(b) citric acid, salts of citric acid or a mixture of citric acid and salts thereof in a total amount of from 22.5 to 26.5 parts by weight, preferably citric acid by itself,
(c) sodium carbonate in a total amount of from 18 to 22 parts by weight,
(d) C₁₆C₁₈-fatty alcohol ethoxylates in a total amount of from 0.45 to 0.55 parts by weight,
(e) polyethylene glycol 6000 in a total amount of from 4.5 to 5.5 parts by weight,
(f) 5-methylbenzotriazole-sodium in a total amount of from 0.9 to 1.1 parts by weight
or
(B)
(a) nitrilotriacetic acid in a total amount of from 24 to 54 parts by weight, preferably 34 to 44 parts by weight,
(b) citric acid, salts of citric acid or a mixture of citric acid and salts thereof in a total amount of from 19.2 to 23.2 parts by weight, preferably citric acid by itself,
(c) sodium carbonate in a total amount of from 32.5 to 36.5 parts by weight,
(d) C₁₆C₁₈-fatty alcohol ethoxylates in a total amount of from 0.45 to 0.55 parts by weight,
(e) polyethylene glycol 6000 in a total amount of from 4.5 to 5.5 parts by weight,
(f) 5-methylbenzotriazole-sodium in a total amount of from 0.9 to 1.1 parts by weight, wherein the composition is in the form of a tablet.

13. An aqueous cleaning liquid for dental instruments, comprising
a dissolved or dispersed composition according to claim 1, wherein components (a), (b), (c), (d), (e), (f) and (g) are present in an amount of 100 parts by weight in total, and
water in an amount of not more than 10,000, preferably 2,000 to 6,000 parts by weight.

14. A process for the preparation of an aqueous cleaning liquid for dental instruments, comprising the following step:
preparation of a mixture comprising a composition according to claim 1, wherein components (a), (b), (c), (d), (e), (f) and (g) are present in an amount of 100 parts by weight in total and water is present in an amount of not more than 10,000, preferably 2,000 to 6,000 parts by weight.

15. A method for the synergistic intensification the ability of nitrilotriacetate, nitrilotriacetic acid or a mixture thereof in removing acid-base cement residues, said method comprising
(a) adding an acid-base cement residue removal enhancing amount of citric acid and/or salts thereof to nitrilotriacetate, nitrilotriacetic acid or a mixture thereof, and
(b) contacting the product of step (a) with an acid-base cement residue.

16. A method for the synergistic intensification the ability of citric acid and/or salts thereof in removing acid-base cement residues, said method comprising
(a) adding an acid-base cement residue removal enhancing amount of nitrilotriacetate, nitrilotriacetic acid or a mixture thereof to citric acid and/or salts thereof, and
(b) contacting the product of step (a) with an acid-base cement residue.

17. A method for removal of contamination based on acid-base cements, said method comprising applying to said cements a composition comprising:
(a) one or more amino acids and/or salts thereof (aminocarboxylates) in a total amount of from 20 to 70 parts by weight, preferably 27.5 to 70 parts by weight,
(b) one or more alpha-hydroxy acids and/or salts thereof in a total amount of from 15 to 45 parts by weight,
(c) one or more alkali metal carbonates and/or bicarbonates in a total amount of from 0 to 50 parts by weight,
(d) one or more surfactants in a total amount of from 0 to 5 parts by weight,
(e) one or more tabletting auxiliaries in a total amount of from 0 to 10 parts by weight,
(f) one or more corrosion inhibitors in a total amount of from 0 to 5 parts by weight, and
(g) one or more other additives in a total amount of from 0 to 55 parts by weight.
wherein components (a), (b), (c), (d), (e), (f) and (g) are present in total in an amount of 100 parts by weight, and
wherein the components are chosen such that the pH of a solution prepared by mixing the composition with 4,000 parts by weight of water is in the range of from 7.0 to 9.5.

18. A method for removal of contamination based on acid-base cements, having the following step:
bringing an object which carries contamination based on acid-base cements into contact with an aqueous cleaning liquid according to claim 13.
